(19) United States
(12) Patent Application Publication
(10) Pub. No.: US 2024/0300071 A1
(43) Pub. Date: Sep. 12, 2024

(54) PROJECTILE PLATFORM SUPPORT SYSTEM

(71) Applicant: Arrow Products USA, LLC, Taylors, SC (US)

(72) Inventor: Asher Samuel Parris, Taylors, SC (US)

(73) Assignee: Arrow Products USA, LLC, Taylors, SC (US)

(21) Appl. No.: 18/594,603

(22) Filed: Mar. 4, 2024

Related U.S. Application Data
(60) Provisional application No. 63/488,727, filed on Mar. 6, 2023.
(60) Provisional application No. 63/471,613, filed on Jun. 7, 2023.

(51) Int. Cl. B25B 1/20; F41A 23/16; F41A 23/18

(52) U.S. Cl. CPC B25B 1/20; F41A 23/18; F41A 23/16

(57) ABSTRACT

A clamp for holding firearms by use of a mounting rail system, such as arca or picatinny, where the rail is held securely in the clamp by a sliding jaw tightened with a knob. The clamp is formed from an arm which itself is held securely within a vise that can be mounted to any suitable surface. The use of a cylindrical arm to form the clamp allows the clamp and firearm to be rotated in the vertical plane. Mounting the vise on a swivel allows for rotation in the horizontal plane. Together, this system provides a user with a stable, infinitely adjustable mounting mechanism that does not affect barrel harmonics.

### BACKGROUND OF THE INVENTION

### 1) Field of the Invention

The current invention is directed to a support device for a projectile platform such as a rifle, pistol, paint marker, nail gun, rivet tool, bow and archery goods, crossbow and the like and can be used for supporting such devices during maintenance and use.

### 2) Description of the Related Art

When maintaining certain equipment, there is a need to securely anchor a device without placing unnecessary strain of force on the device. In the example of a pistol or rifle, forces on the device, such as from clamps, vises and the like, can affect the performance resulting in an undesirable point of impact. U.S. Pat. No. 7,356,960 discloses a special type of vise for holding the gunstock necessarily placing force on the gunstock when the gunstock is placed into and secured in the vise. When installing accessories, performing maintenance, making adjustment to a rifle or pistol, a vise places forces on the platform. When such actions are taken and then the platform is removed from the vise, the removal of the forces caused by the vise can change the platform and thereby change the point of impact, accuracy, settings, and the like.

Further, when maintenance is performed on such a platform, it is advantageous to secure the platform in a certain position so that the platform can be maintained or otherwise adjusted. U.S. Pat. No. 8,905,391 shows two clamps that are attached to a bench to support the firearm during cleaning, maintenance, adjustment, sighting and repair operations at a workstation. However, it is obvious that the firearm can only be supported with the bore being parallel to the ground. U.S. Pat. No. 7,584,690 also has this limitation but does include the ability to support a firearm when the breach of opened. Nevertheless, the ability to support firearms in multiple orientations is not provided. United State U.S. Pat. No. 8,516,734 has the same disadvantage and limitations. U.S. Pat. No. 8,297,605 includes a ball joint allowing some movement away from the planar configuration of the previously discussed patents but includes a significant disadvantage in that the design allows the platform to fall when loosened resulting in the action or muzzle contacting a surface which can negatively impact performance and even damage the platform and firearm. Further, these attempts to provide a system for securing a platform, including a rifle, show that allowing multiple configuration and orientations, reducing, or eliminating the risk of the platform moving out of control is a problem that needs much attention.

Further, competition and precision shooters looking to sight in a rifle have long sought means to solidly anchor a firearm, consistently, and without affecting the point of impact. Barrel harmonics greatly affects the point of impact of a bullet and the consistency of a group of shots. Pressure upon the barrel and the barrel attachment affects barrel harmonics. Over the years, stocks have been developed to create both a solid means of holding a barrel along with consistent harmonics. Techniques have ranged from free floating the barrel so that it does not touch the stock to glass bedding the barrel such that as much surface contact as possible is had. To place a vise on the stock or barrel defeat the purpose of these attempts to improve accuracy.

While the stock holds the barrel, the stock is the connection to the outside world. From giving the user a means to hold the firearm, to providing a connection point for accessories, and in some cases even scopes. When a stock holds a sight, such as a scope, the mount must be secure and capable of replication. One way that this has been accomplished is by using mounting rails. Such rails, commonly configured as picatinny or arca, have been used to create solid mounting points for scopes, sites, night vision, thermal and other optics. In recent years the use of rails have expanded to include mounting points for slings, flashlights, bipods, and other accessories. The rails provide a solid mounting point as an integral part of the stock system of the firearm. Repeatability is achieved by indexes along the rails which allow the user to mount an item in an exact location each time.

When a user holds a rifle, he generally cannot place enough pressure upon the stock to change the harmonics of the barrel. This, however, changes when the user attempts to place the rifle upon a bench or in a vise. The unforgiving solid surface of the bench does affect the stock which in turn affects harmonics. The vise can place unwanted force on the platform including the stock, action and even barrel. When the pressure of the vise is removed, the components of the platform can also slightly shift so that when a component is installed while the rifle is in the vise, removal of the vise can cause modifications that create disadvantages.

This effect is amplified if the user attempts to hold the firearm in a vise, lead sled, cradle, or other device designed to hold the firearm instead of the user. The tighter a device holds the rifle, the more likely it is to pinch a stock or otherwise change the harmonics of the barrel. When removed from the vise or other apparatus, the configuration of the rifle can change negatively impacting performance and accuracy.

Therefore, it is one objective of the present system to provide a vise specifically designed to grip a mounting rail taking advantage of solid mounting surface designed to not affect barrel harmonics. Use of the rail further provides repeatable performance by allowing the user to mount the projectile device in the exact same manner each time.

### BRIEF SUMMARY OF THE INVENTION

The above objectives are accomplished by providing a support system of a vise, having a tight configuration and a loose configuration, holding an arm having a distal end and a proximal end. At the proximal end of the arm and defined within the arm are one or more guide rod openings and a tightening member. A sliding jaw containing one or more guide rods is received by the proximal end of the arm, and a tightening member hole within the sliding jaw is in operable communication with the tightening member opening in the proximal end of the arm.

The arm, which may be cylindrical in shape, has one or more planes each plane having a mating surface defined by a plane anchor edge, defined from the proximal end of the arm, and a plane mating edge defined from the sliding jaw. Said plane anchor edge and mating edge are adapted to receive an accessory rail. Such rail may be taken from the group consisting of a picatinny rail, arca rail, dovetail rail, Warsaw Pact rail, weaver rail, SOPMOD, Magpul M-LOK, UIT rails, freeland rail and any combination.

The sliding jaw is attached to the arm by an adjustment knob attached to a threaded shaft extending through the sliding jaw and into the tightening member opening in the proximal end of the arm. Together the arm and the sliding jaw define a tight position and a loose position. The user adjusts the sliding jaw by rotating the adjustment knob in a first direction sliding the sliding jaw away from the arm towards the loose position and rotating the adjustment knob in a second direction sliding the sliding jaw toward the arm towards the tight position.

A spring may be disposed within the guide rod opening to bias the sliding jaw toward the loose position. The sliding jaw guide rod can be cooperatively associated with the guide rod opening defined in the arm to allow the sliding jaw tolerance to compensate for a defect in the accessory rail. With correct tolerances the sliding jaw can compensate for out of tolerance products as it moves from the loose position to the tight position.

While a single plane has been described on the arm, the arm may include any number of planes, each plane including a mating surface with associated edges, defined within the plane, and configured to accept an accessory rail on said plane of the arm and wherein the sliding jaw is similarly configured to engage additional planes.

The vise may include a clamping knob to tighten and loosen the vise about the arm. The arm can be further manipulated in the vise by rotating about a longitudinal axis of the arm and sliding from side to side along the longitudinal axis of the arm. The vise may also include a tool receptacle, which may be threaded, and a tool tray may be formed or attached to a top of the vice. A portion of the vise may be magnetized to hold small parts. The vise may sit on a mounting platform having mounting points capable of affixing the vise to a surface. The mounting platform may also include a swivel or places to which to connect accessories.

The arm may be modified to include a protrusion on the distal end which prevents the arm from sliding out of or disengaging from the vise. The arm may be further contoured on the proximal end against the clamp to allow room for the platform being held by the clamp.

At its core, the support system comprises an arm with a distal end and a proximal end with a tightening member opening defined in the arm at proximal end. A jaw is adapted to be received to the proximal end of the arm. On the proximal end of the arm is an anchor edge and on the jaw is a mating edge, together these edges define a clamp adapted to receive an accessory rail. An adjustment know with threaded shaft operably connects the jaw to the proximal end of the arm where the threaded shaft is received in the tightening member opening. When the adjustment knob is rotated in a first direction the jaw moves away from the arm towards a loose position and when the knob is rotated in a second direction the jaw moves toward the arm towards a tight position.

While an embodiment of the invention has guide rods to align the jaw to the arm, the jaw may include other guide mechanisms cooperatively associated with a receiving mechanism defined in the arm which together align the jaw to the arm. Such mechanisms may include guide rods, ridges, or other designs that work cooperatively. The guide mechanisms allow tolerances in the fit of the arm to the jaw to compensate for defects in the accessory rail as the jaw moves from the loose position to the tight position thus maintaining alignment to securely engage the accessory rail.

A magazine well adapter may be used with vise and clamp described above. The magazine well adapter includes a magazine block with a proximal end and a distal end. The proximal end is adapted to be partially received in a platform opening, such as the magazine well of a firearm, and the distal end includes a mounting surface, such as an accessory rail taken from the group consisting of a picatinny rail, arca rail, dovetail rail, Warsaw Pact rail, weaver rail, SOPMOD, Magpul M-LOK, UIT rails, freeland rail and any combination. A tightening member is received within a recess within the proximal end of the magazine block such that a portion of the tightening member is received within the platform opening when the magazine well adapter is inserted into a platform opening. An adjustment knob attached to a threaded shaft extends through the tightening member into the proximal end of the magazine block. The tightening member is held in place by a pin and is capable of rotating along the longitudinal axis of said pin.

The magazine block and tightening member define a tight position and a loose position. When the adjustment knob is rotated in a first direction the tightening member moves outward from the proximal end of the magazine block within the platform opening towards the tight position and when the knob is rotated in a second direction the tightening member moves inward the proximal end of the magazine block within the platform opening towards the loose position.

The proximal end of the magazine block and the distal end of the magazine block may be rotatably attached to one another in such manner that the distal end and proximal end rotate relative to one another. A handle attached to a threaded shaft connects the proximal end of the magazine block to the distal end of the magazine block. The magazine block has a moveable position and a secured position wherein when the handle is rotated in a first direction the proximal end of the magazine block and distal end of the magazine block can rotate relative to one another where attached and when the handle is rotated in a second direction the proximal end of the magazine block and distal end of the magazine block are secured to one another.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a perspective, assembled view of an embodiment of the invention.

FIG. 2 is a perspective, assembled view of an embodiment of the invention.

FIG. 3 is a perspective, assembled view of an embodiment of the invention.

FIG. 4 is an exploded, perspective view of an embodiment of the invention.

FIG. 5 is a perspective, assembled view of a part of an embodiment of the invention.

FIG. 6 is a perspective, assembled view of a part of an embodiment of the invention with internal components shown in dashed line.

FIG. 7 is a perspective view of a part of an embodiment of the invention.

FIG. 8 is a perspective view of an embodiment of the invention in use.

FIG. 9 is a perspective view of a component of the invention.

FIG. 10 is a perspective view of an embodiment of the invention in use.

FIG. 11 is an exploded view of a component of the invention.

FIG. 12 is a perspective view of a component of the invention.

FIG. 13 is a perspective view of a component of the invention.

### DETAILED DESCRIPTION OF THE INVENTION

With reference to the drawings, the invention will now be described in more detail. This system can include a clamp that engages with a platform such as a firearm, camera, or other equipment, using a mounting rail on the platform (such as a rail on a stock or magazine block) so that the system supports the platform securely. Mounting rails are designed to provide a solid anchor point, are indexed to allow repeated and exact mounting, and can be clamped or squeezed without negatively impacting operations, accuracy, and barrel harmonics. A mounting rail can be securely held in a rail clamp integrally formed within a shaft or arm which can be secured in a vise which itself is attached to a table or other solid shooting rest. Therefore, the vise is not in direct contact with the platform.

By use of the combined vise, support arm and clamp (and potentially a magazine block) that can engage with a rail, the user is able to solidly anchor the platform, in a repeatable manner, without affecting barrel harmonics or other delicate configurations of the platform. Maintenance and adjustment can be made to the platform, accessories added or removed, and other actions taken without disturbing the configuration of the platform or risk of dropping the platform.

The clamp can be formed integral with an arm, which may be round, square, or any other convenient shape and a moving jaw. An end of the arm proximal to the clamp can be configured to accept one side of a mounting rail such as a picatinny rail, arca rail, dovetail rail, Warsaw Pact rail, weaver rail, SOPMOD, Magpul M-LOK, UIT rails, or freeland rail to support the platform. In one embodiment, the arm features multiple planes adapted to receive a portion of a rail and can be configured to accept different sized mounting rails. The arm can include a first rail size on the surface of the arm and a second rail size on a second surface of the arm. Each surface of the arm may also be recessed to accommodate the bulk of the platform adjacent to the mounting rail. The proximal end of the arm can have a removably attached moving jaw that can be configured to accept a side of the mounting rail. The sliding jaw can be oriented to the arm through one or more guide rods protruding from the arm and passing through corresponding holes defined in the arm. The rods can be attached to the sliding jaw so that the rods of the sliding jaw can be received into the opening defined in the arm. The guide rods can protrude from the sliding jaw into holes defined in the arm. Other means of orienting the sliding jaw to the arm are possible, such as corresponding grooves and ridges, and are included within the scope of this invention. The means of orientation may purposefully include loose tolerances, or slop, to allow the arm and sliding jaw to engage a rail or other surface which is out of standard specification.

The proximal end of the arm can include a threaded opening defined in the arm and adapted to receive a threaded shaft that can extend through the sliding jaw and into the arm. A handle or knob can be attached to the threaded shaft and used to position the sliding jaw from a loose position to a tight position. In the loose position, a rail from a platform can be received in the space between the arm and the sliding jaw, When the sliding jaw is in the tight position, the rail can be secured to the system. The clamp can be opened and closed by loosening or lightening the handle or knob. With the clamp opened, a user can insert an appropriate mounting rail between the arm and the sliding jaw oriented such that the mounting rail is accepted by the arm and sliding jaw. The user can then tighten the knob securing the mounting rail in the clamp. The arm can include an arm clamp surface that is angled relative to vertical and can be al an acute angle. The sliding jaw can include a sliding jaw surface that can be at an acute angle so that the two surfaces secure a rail to the clamp.

The arm can be received and secured to a vise. In one embodiment, the arm may be a uniform shaft and the vise may simply be a block, having an arm opening to receive the arm. The vise can include a cut on one side so that a vise upper portion and a vise lower portion can be tightened to concentrically secure the arm or loosened to allow the arm to slide and rotate within the vise. In one embodiment, the vise can include a slot along one side to allow flex between the upper portion and the lower portion along a plane parallel within the arm. The vise can include a vise knob or handle oriented over the cut in the vise so that the vise knob can position the vise in a vise tight position and a vise loose position. A vise threaded shaft can run through an opening in the vise to position the vise from a tight and loose position. By tightening the vise knob, the vise is flexed closed gripping the arm. When the vise knob is loosened, the vise relaxes its grip on the arm allowing it to move.

In one embodiment, the arm can be circular in cross section (e.g., a rod or cylinder), and can be rotated in addition to moving laterally along the vise. This cooperation between the vise and the arm allows the platform to be held in the clamp to be rotated in the vertical plane when the vise is oriented in the horizontal plane. Alternatively, the vise could be mounted vertically, and the platform held by a mounting rail located on the platform (e.g., on a side of the stock). By combining a uniform cylindrical shaft for the arm and configuring the vise such that it grips the arm concentrically, the arm can be rotated and held within the vise in 360 degrees allowing the user to rotate the platform. The arm may also be moved in and out of the vise allowing the user to move the platform to or from the vice as desired.

The distal end of the arm may feature a protrusion or stop to prevent the arm from sliding completely out of the vise. Such protrusion may be an end slide stop removably attached by a mechanism such as a screw. Alternatively, the protrusion may be integral to the arm thus requiring insertion into the vise from the other end. In one embodiment, the protrusion engages with the vise such that the distal end of the arm cannot pass through the vise.

The vise may feature a recessed tray on the top for the purpose of holding loose parts. The tray may be either attached to the top of the vise or integrally formed into the vise. The tray may be magnetized to further assist in holding loose parts. The top of the vise may also feature a tool attachment point. This point may simply be a threaded hole able to accept a rod or other tool holding device. In one embodiment, the point accepts a tool holder comprising a solid shaft threaded on one end and connected to a flexible shaft on the other end. The flexible shaft is then connected to an attachment point for a tool such as a flashlight.

The vise may be carried by a plate through a plurality of screws or other attachment points. The plate then provides an easy mounting mechanism for use in mounting the vise to a multitude of surfaces. The plate may feature a plurality of holes of different sizes and locations. The plate may also be an L-bracket or other design where it is necessary to mount the vise to surfaces on two different planes. The vise may be mounted to the plate by a swivel allowing rotation of the firearm in the plane perpendicular to the plane of rotation allowed by the cylindrical arm. Together this would allow the user to orient the firearm to point in any desired direction. The swivel device may feature a locking knob allowing the user to tighten and prevent further rotation of the vise.

The vise, or the plate upon which it is mounted, may also accept a shelf or other platform for tools, organization, or simply holding loose screws.

The clamp may be used to secure a magazine block (or magazine well adapter) having rails. The magazine well adapter can be configured such that the proximal end of the magazine adapter is insertable into the mag well of a firearm. The distal end can include a rail to engage with the clamp. While the mounting rail system is shown as integrally formed to the magazine well adapter, it could just as easily be formed by attaching a mounting rail to the distal end of the magazine well adapter. The mounting rail could be a standard picatinny rail, arca rail, or some other design of rail suitable for providing a secure attachment point. The user can insert the magazine well adapter into the magazine and then clamp the distal end in the clamp. With the clamp secured in the vise, this provides the user a convenient way to hold the firearm while he works upon it. The magazine well adapter may also feature a tool attachment point, such as a threaded hole, to be used with tools such as those previously discussed.

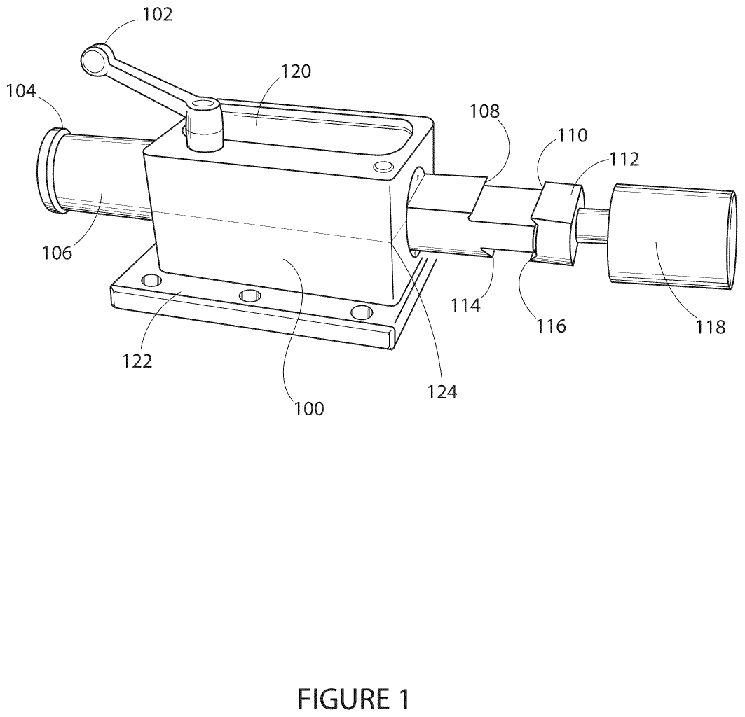

Referring to FIG. 1, an assembled embodiment of the invention is shown with anchor edges of two clamps formed integrally from the arm 106 on the end proximal the user. The clamps on the proximal end are designed to clamp upon and hold various mounting rails such as a picatinny rail or arca rail. In the preferred embodiment shown there are two planes formed on the arm by milling alternative sides of the arm flat. The planes can engage a corresponding flat portion of a rail that is attached to a platform. A first clamp is defined by a first plane anchor edge 108 and a first plane mating edge 110. The first clamp is located along a first plane of the arm 106. A second clamp, located on a second plane of the arm 106, is defined by a second plane anchor edge 114 and a second plane mating edge 116. The first and second plane mating edge are integrally formed (but could be attached to) the sliding jaw 112. Sliding jaw 112 is capable of moving towards and from the arm 106 along the axis of the arm 106. The sliding jaw 112 may include one or more guide rods that hold it in line with the axis of the arm. The sliding jaw 112 is tightened (moved closer to the arm) or loosened (moved away from the arm) by rotating handle 118. Handle 118 includes a threaded stud which runs through and through the sliding jaw and is received into the arm 106 along the axis. Each set of plane anchor edges and plane mating edges are opposed each other and work in conjunction with the sliding jaw 112 such that tightening the sliding jaw 112 will cause the two edges to come together and grip an appropriately sized rail. When sliding jaw 112 is abutted to arm 106, the distance between first plane anchor edge 108 and first plane mating edge 110 is slightly narrower than the mounting rail which the first plane is configured to accept. In a standard embodiment the clamps are of two different sizes. This allows the invention to be used with multiple size rails, such as a picatinny rail, arca rail, dovetail rail, Warsaw Pact rail, weaver rail, SOPMOD, Magpul M-LOOC, UIT rails, freeland rail, by simply rotating the arm. Such rails are commonly used with firearms, cameras, and other equipment to mount and hold accessories. While this arm is shown cylindrical in shape, it could be any geometrical shape suitable for a shaft. This configuration allows the user to rotate arm 106 to select between the first plane mounting option and the second plane mounting option. While the clamp is shown with a two-plane mounting option, it could be designed with any number of planes and mounting options.

Arm 106 can be received and secured in a vise block 100. The vise block 100 can be formed from a single block or can be one or more pieces. The vise block 100 can define a bore to accept arm 106. Vise block 100 is further modified on a side by a slit 124, cut through-and-through, from the outside to the bore which runs end-to-end. Vise block 100 may include handle 102 for tightening the vise block 100. Handle 102 is connected to a threaded shaft which runs through a hole drilled in vise block 100 above the slit 124 and is then threaded into a hole in vise block 100 below the slit 124. Handle 102 can be used to turn the attached shaft and tighten or loosen pressure applied by vise block 100 to arm 106. When handle 102 is tightened, vise block 100 squeezes pressure onto arm 106 holding it in place. Together vise block 100 and handle 102 with attached shaft create the vise.

The arm 106 runs through and through vise block 100 with the proximal and distal end of the arm extending, one from either side of the vise block. The distal end includes a rim stop 104 that may be integrally formed in the arm 106 or which may be attached to the arm 106 by means of a fastener. The vise block may be loosened or tightened by vise handle 102 which gradiently closes the receiving hole in the vise by pinching the slit 124 shut. The receiving hole in the vise is configured to accept the arm 106 with minimal excess tolerances such that the slightest tightening of vise handle 102 will pinch the vise block 100 close and tighten the vise block grip on the arm 106. When the vise block is loosened, the arm can slide freely back and forth in the vise block. In the case of a cylindrical arm, the arm can also freely rotate. This allows the user to position the platform held in the clamp by moving it towards or away the user and by rotating the platform. Once vise handle 102 is tightened, the arm is secured and the platform is held steady. Rim stop 104 prevents the arm from sliding out of vise block 100 when it is loosened.

Vise block 100 may also include an integrally formed tray 120, which can be used to hold small parts when the user is working on a platform secured in one of the clamps. Tray 120 can be attached to the block 100 as a separate item, or may simply be formed from block 100 by milling out the top. Tray 120 may be further modified to secure loose parts by magnetizing, providing a sticky or ridged surface, or any similar enhancements that prevent objects placed on top of block 100 from being lost.

The vise block 100 may also be secured, or integrally formed with, a mounting plate 122. Mounting plate 122 may feature mounting points to secure the mounting plate and vise block to a work bench or other stationary surface. The mounting plate 122 may also include mounting points for attaching accessories to the mounting plate such as an additional tray which may be magnetized. The mounting plate 122, while shown as a flat bracket, can be of any shape, such as an L-bracket, that facilitates mounting the vise to a desired surface. Mounting plate 122 may be attached to the vise by a swivel mechanism that allows vise block 100 to swivel above mounting plate 122. A tightening mechanism may be added to mounting plate 122 to lock vise block 100 into place and prevent further swiveling when the desired position is reached.

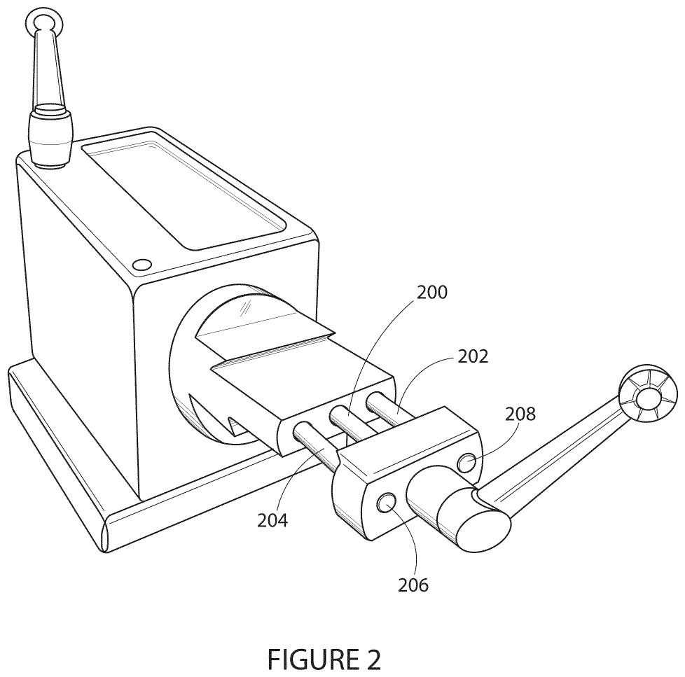

Referring to FIG. 2, the sliding jaw moves along guide rods 202, 204. Sliding jaw 112 can be moved to a tight position wherein it abuts arm 106, or to an loose position away from arm 106, as shown in FIG. 2. Guide rods 202, 204 provide strength and stability in the connection between sliding jaw 112 and arm 106. The same could be accomplished with other means such as opposing peaks and valleys on arm 106 and sliding jaw 112. In the embodiment shown, guide rods 202 and 204 are respectively mounted in guide rod holes 208 and 206. The guide rods 202 and 204 are then operatively received in corresponding holes in arm 106. The holes in arm 106 can be drilled to a depth to accept the entire length of the guide rods 202, 204 when sliding jaw 112 physically abuts arm 106. It is possible to reverse this arrangement by mounting the guide rods 202, 204 in the holes in arm 106 and allowing the guide rods 202, 204 to be operatively received into holes 206 and 208. Sliding jaw 112 is moved from the open to the close position by means of handle 118 which is attached to threaded shaft 200. In a preferred embodiment, the guide rods are received in the guide rod holes in a manner that allow the mating surface of the sliding jaw to disorient slightly from the mating surface of the arm such that an out of specification accessory rail can still be engaged by the a plane anchor edge and a plane mating edge despite poor manufacturing of the accessory rail. Handle 118 is shown in two different configurations but could just as easily be shown in other configurations that serve the purpose of providing the user with a grip to turn threaded shaft 200. Threaded shaft 200 runs through sliding jaw 112 and is received by a threaded hole in the end of arm 106. By tightening handle 118 sliding jaw 112 is moved towards arm 106 by means of the threaded shaft received in the threaded hole. When a mounting rail is placed between first plane anchor edge 108 and first plane mating edge 110, handle 118 is tightened moving sliding jaw 112 towards arm 106, closing the distance between first plane anchor edge 108 and first plane mating edge 110. This process is continued until first plane anchor edge 108 and first plane mating edge 110 contact the mounting rail. The user can then torque handle 118 to the desired pressure on the mounting rail. Thus, the object with mounting rail, such as a firearm, is secured in the clamp. The sliding jaw 112 may be biased out by including springs in the mounting holes operatively receiving the guide rods 202, 204.

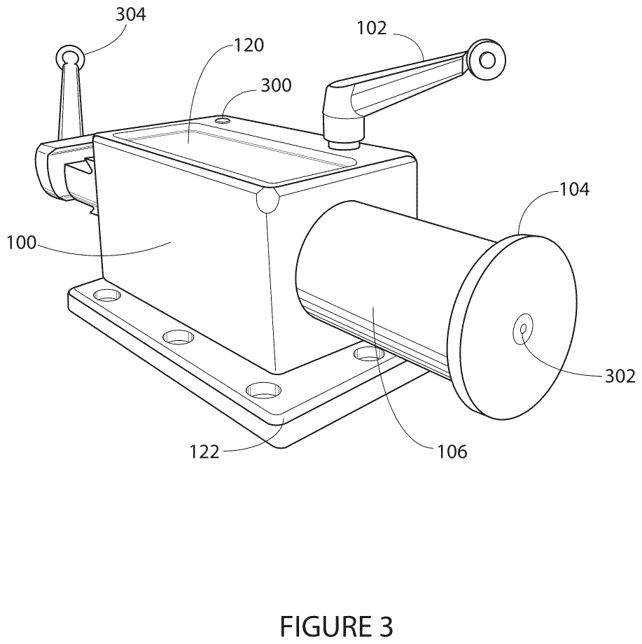

Referring to FIG. 3, the distal end of arm 106 is shown secured in vise block 100. Rim stop 104 is seen secured to arm 106 by fastener 302. The rim stop 104 on the distal end of the arm prevents arm 106 from sliding through vise block 100. This rim stop 104 prevents arm 106 from coming out of the vise when it is loosened by catching on block 100. Rim Stop 104 may be integrally formed into arm 106, or it may be attached to arm 106 by some mechanism such as fastener 302. Fastener 302 is shown as a screw, but it could be replaced with any number of attachment mechanisms such as bolts, screws, or pins, or a more permanent attachment such as a weld. Rim stop 104 may simply catch on the end of vise block 100, or vise block 100 may be recessed to smoothly receive and rim stop 104.

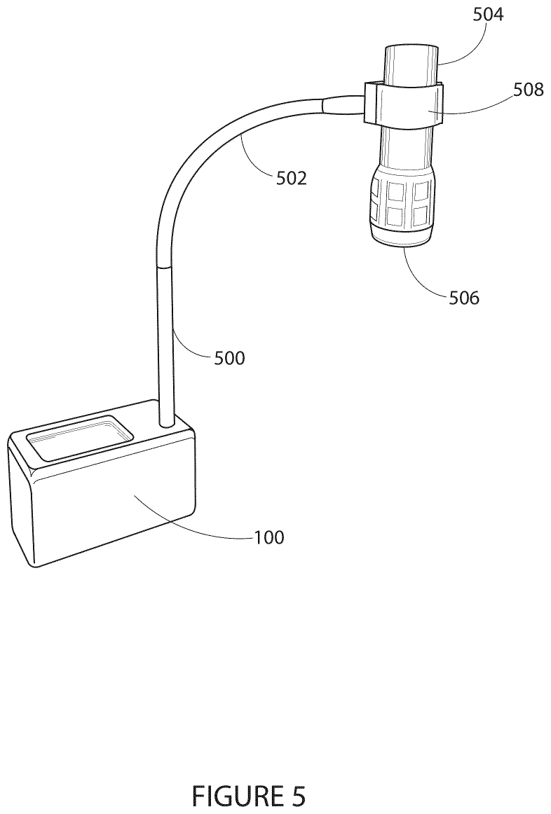

Vise block 100 is shown with a tool attachment point 300. Point 300 may be as simple as a threaded receptacle able to accept a threaded shaft as shown in FIG. 5. Clamp handle 304 is shown in a different configuration form prior handles 118. Tray 120 and vise handle 102 are shown for reference.

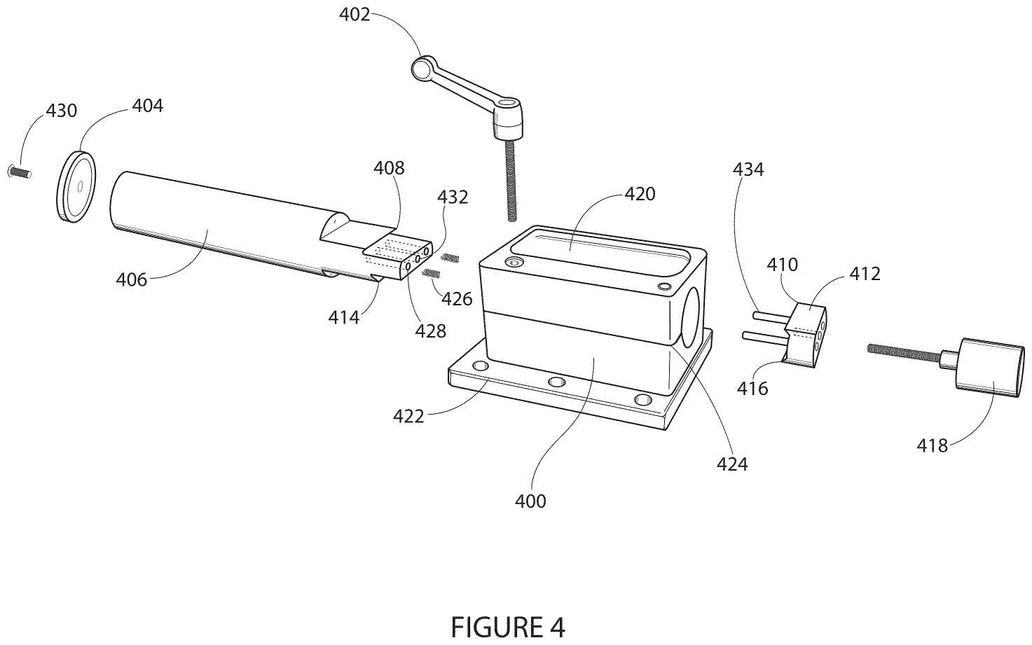

Referring to FIG. 4, an exploded view of the invention is shown with components separated for viewing. Arm 406 provides the basis upon which the clamp and vise operate. Arm 406 includes first plane anchor edge 408 and second plane anchor edge 414 on the proximal end of arm 406. On the distal end of arm 406 is rim stop 404 which is attached by fastener 430. Fastener 430 is shown as a screw, but it may also be a bolt, rivet, pin, weld or any other sort of fastener. The proximal end of arm 406 is shown with guide holes 428 and a threaded bore 432. Each guide hole 428 receives a guide arm 434 protruding from sliding jaw 412. Sliding jaw 412 is attached to arm 406 by handle 418. Handle 418 includes a protruding threaded stud which runs through and through sliding jaw 412 and operably engages in a threaded bore 432 along the axis of arm 406. Each guide rod hole 428 may include springs 426 to bias the sliding jaw 412 in an open position. When handle 418 is engaged and tightened, the sliding jaw 412 is moved towards arm 406 and to the tight position. Sliding jaw 412 includes first plane mating edge 410 and second plane mating edge 416. As sliding jaw 412 is moved towards the tight position, the first plane anchor edge 408 and first plane mating edge 410 will engage an appropriate sized rail placed between the two edges. As handle 418 is tightened, the edges clamp upon the rail holding it securely in place. If it is desired to use a different sized rail, the second plane anchor edge 414 and second plane mating edge 416 (i.e. second clamp) can be used. Rotating the arm 406 allows for easy selection between the two clamps. When handle 418 is engaged and loosened, the sliding jaw 412 is moved to a loose position opening the space between the plane anchor edges and plane mating edges.

Handle 402 runs through and through the top portion of vise block 400, across slit 424, and into a threaded bore in the bottom portion of vise block 400. When the handle 402 is loosened, vise block 400 relaxes, slit 424 opens, and arm 406 is able to rotate and slide within vise block 400. When the handle 402 is tightened, vise block 400 is pinched at slit 424 closing slit 424 and restricting the hole through the bore until arm 406 is securely gripped by vise block 400. Arm 406 runs through a bore in vise block 400 where the constricting functions of vise block 400 may act upon the arm 406. The vise block 400 may further include a tray 420 attached to or integrally formed from vise block 400 that is used to hold small parts. This tray 420 may be magnetized, lined with a sticky material, grooved, or otherwise modified to retain any small parts placed in the tray 420.

Vise block 400 is mounted to mounting plate 422. While the mounting plate 422 may be attached by a permanent fastener, such as welding, or may be fixed, such as by screws or bolts, the mounting plate 422 may be rotatably attached to vise block 400 by use of a swivel or other means that allow for manipulation of the position of vise block 400. A locking mechanism may be included on the mounting plate 422 or the vise block 400 to secure the vise block 400 in a fixed position when it is no longer desirable to rotate or swivel the device.

Referring to FIG. 5, vise block 100 is shown with tool shaft 500 connected to tool attachment point 300. Tool shaft 500 is threaded on one end for attachment to point 300 (from FIG. 3). On the opposite end shaft 500 is attached to a tool such as holder 508. Holder 508 is designed to clamp tool 504. While tool 504 is shown as a flashlight or flashlight holder, it could easily be a laser, screwdriver, or some other tool. In one embodiment there is a flex-shaft 502 connecting shaft 500 to holder 508. Flex-shaft 502 allows holder 508 to be adjusted in location. This is helpful when positioning tool 504, and in the embodiment shown, allows the user to adjust the light in use by directing the orientation of lamp 506.

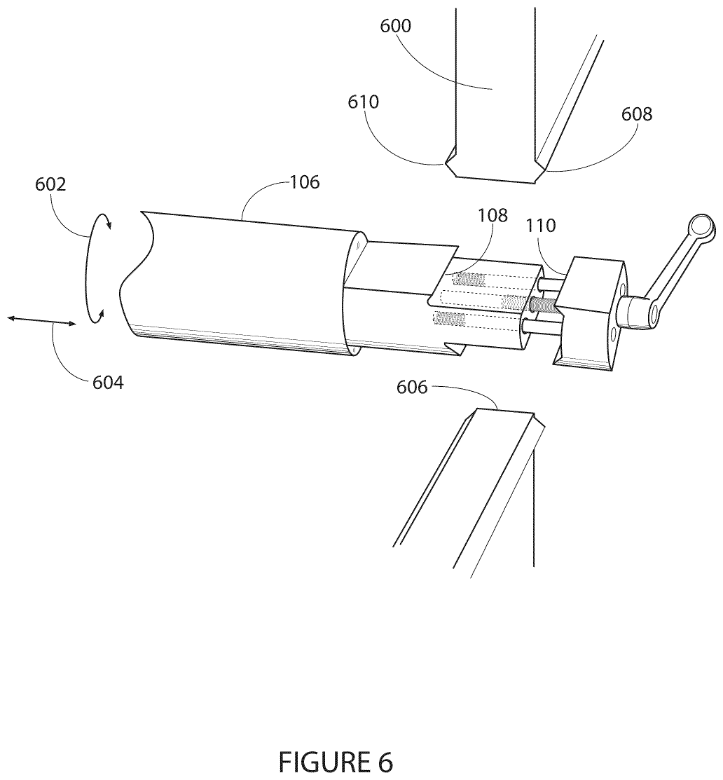

Referring to FIG. 6, the arm 106 can include a first plane anchor edge 108 and a first plane mating edge 110 that can engage with the opposing edges (610 and 608) of a rail and secure the rail to the clamp. As the sliding jaw containing first plane mating edge 110 is tightened, first plane anchor edge engages rail edge 610 and first plane mating edge engages rail edge 608. Upon torquing the tightening mechanism, the first plane anchor edge and first plane mating edge grip the rail edges 610 and 608 through tension securing the rail in the clamp. The rail may be attached to or integrally formed from any number of platforms. As shown, the rail is integrally formed with magazine well adapter 600. The arm 106, and the clamp formed therein, can rotate about a direction 602 and move back and forth about a direction 604. A different sized rail 606 can be secured to another plane of the arm allowing the clamp to support multiple sized rails without the need for additional sliding jaws. A guide rod can be attached to the sliding jar and can be received in the arm. A spring can be disposed in the opening in the arm that receives the guide rod and bias the sliding jaw open.

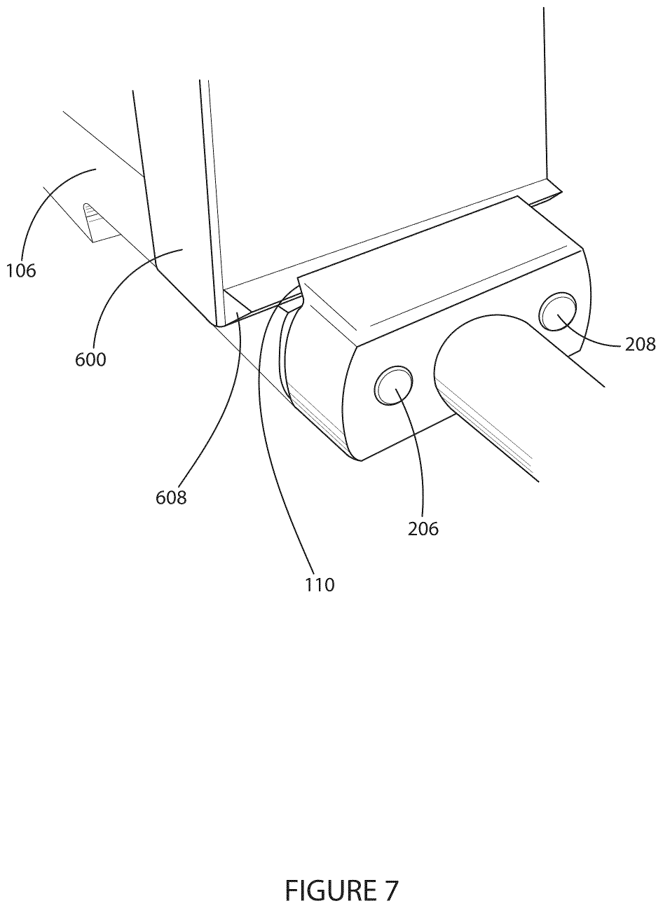

Referring to FIG. 7, the clamp is shown securing magazine well adapter 600. The magazine well adapter is shown with an integrally formed rail including edge 608. Said rail could also be attached to magazine well adapter 600 rather than formed integrally therefrom. Rail edge 608 is engaged by first plane mating edge 110 formed on the sliding jaw which is stabilized by guide rods secured in guide rod holes 206 and 208 and received within arm 106. On the proximal end, magazine well adapter 600 is sized to be received into a firearm magazine well. On the distal end of magazine well adapter 600 is mounting rail adapter formed with protruding edges (edge 608 shown). Mounting rail adapter is designed like a picatinny or arca rail and is sized to be received into the clamp and held between the first plane anchor edge and first plane mating edge 110 or the second plane anchor edge and the second plane mating edge depending on the size of the mounting rail adapter. While mounting rail adapter is shown integrally formed with magazine well adapter 600 in FIG. 7, mounting rail adapter could be made from a separate material either permanently or removably attached to magazine well adapter 600. The magazine well adapter could be used to hold an assembled or disassembled firearm.

For reference, arm 106 is labeled to show the position of the clamp and magazine well adapter 600 in relation to an embodiment of the invention as a whole. Referring back to FIG. 6, the magazine well adapter 600 is shown before engagement with the clamp. FIG. 7 shows the same magazine well adapter, from a slightly different angle, engaged in the clap on the proximal end of the arm 106.

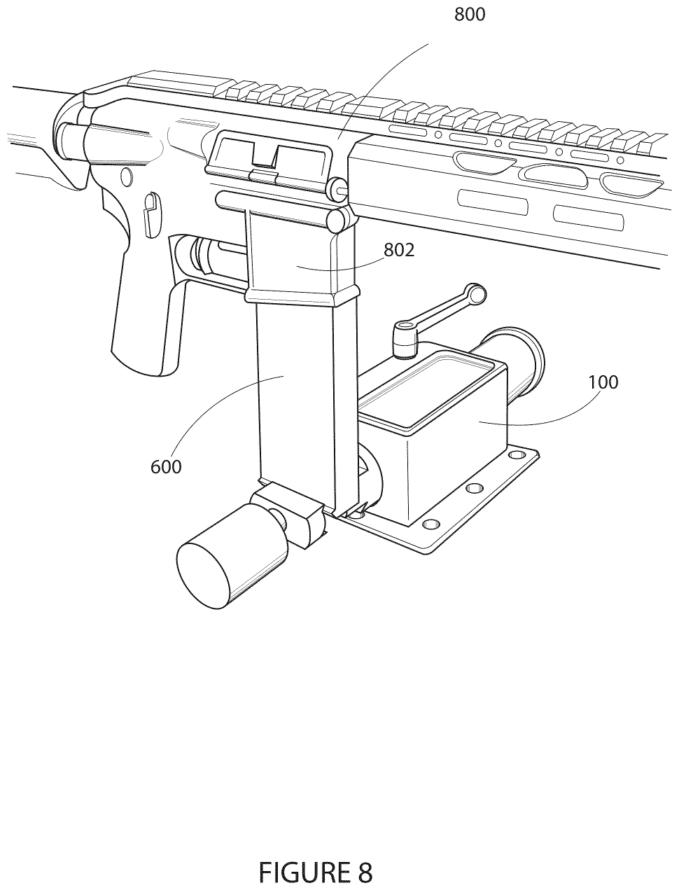

Referring to FIG. 8, the magazine well adapter 600 can be adapted to be received in the magazine well 802 of a firearm 800. The proximal end of the magazine well adapter 600 is inserted into magazine well 802. The distal end, including the edges comprising the mounting rail adapter, is clamped in place by the clamp on the arm. The distal end can include physical characteristics of a rail mounting system used for a firearm but attached to a magazine well adapter. Therefore, the platform, shown as a firearm, can receive the magazine well adapter and the magazine well adapter can be secured to the clamp to hold the platform in a specific location. The arm is held in vise block 100 with all properties of that system as previously described. This also allows the platform to rotate and slide relative to the vise block so that the platform can be moved between orientations to facilitate maintenance, the addition of attachments, removal of attachments and the like.

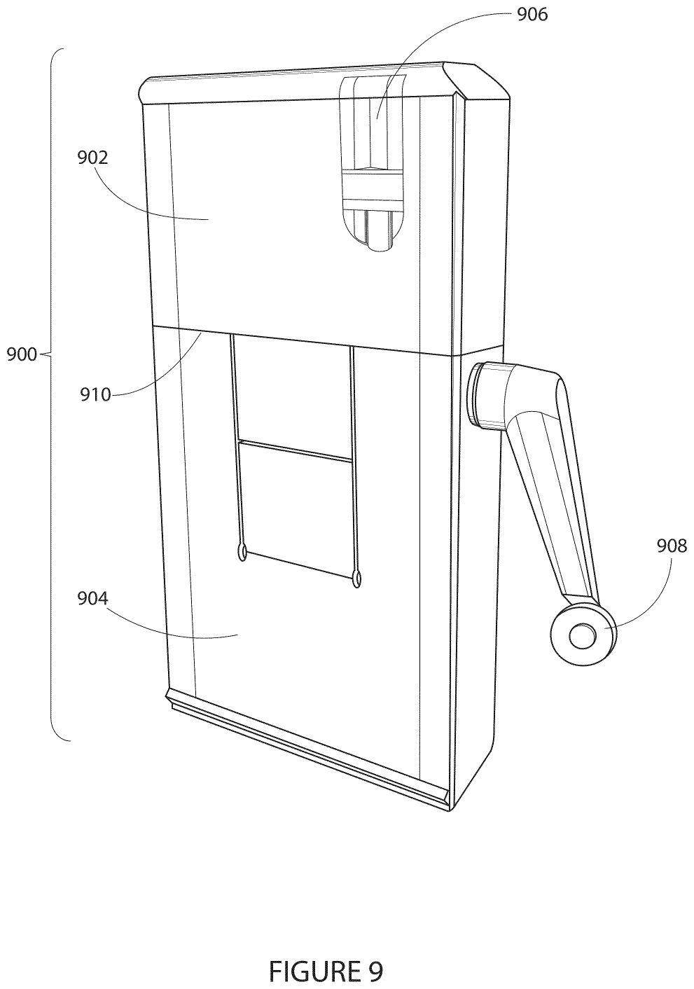

Referring to FIG. 9, the magazine well adapter 900 is shown in a vertical position wherein a top portion 902 and a bottom portion 904 are planar. In one embodiment, the magazine well adapter 900 can include a top portion fixed to the bottom portion. In one embodiment, the top portion can be hingably attached to the bottom portion so that the top portion can rotate (at 910) relative to the bottom portion. Handle 908 is used to enable the hinge at 910 allowing the top and bottom portions to rotate relative to one another. When handle 908 is tightened, the hinge is disabled and the top portion 902 and bottom portion 904 are stabilized. In one embodiment, a magazine catch 906 is defined in the proximal end of the magazine well adapter. Magazine catch 906 is located and configured to engage the magazine retention mechanism of the desired platform. The magazine catch 906 may be integrally formed from the magazine well adapter 900, but it could, in the alternative, be formed from an insert of different material, such as hardened steel, where different properties are desired in the material used to construct the magazine well adapter and the magazine catch. In a preferred embodiment, the magazine latch section 906 may be defined within a hardened insert, such as steel, titanium, or any similar material, to prevent premature wear while allowing the main body of the magazine well adapter to be made of a softer material such as aluminum, plastic, brass, or any similar material.

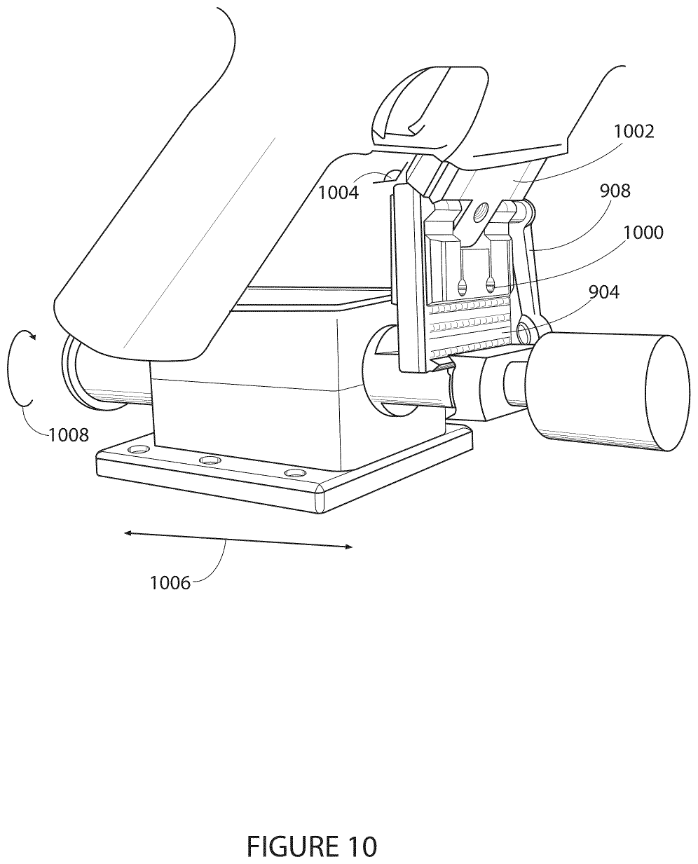

Referring to FIGS. 10, The rotating of the top portion 1002 of the magazine well adapter, relative to the bottom portion 904, provides for the tilting of the platform at varying angles 1004 relative from vertical. The hinge can rotate on either side vertically so that angle 1004 can be greater or less than 90°. The hinge may be tightened by a hinge handle 908. In one embodiment, the hinge handle may function by use of a threaded stud that when tightened pinches slots 1000 in the magazine well adapter holding the hinge in place through friction. The uses for the magazine well adapter can include with a vise, clamp static mount, and can be used for gun smithing to bore sighting. The magazine well adapter can include various slots or ridges or other designs, that can assist with securing the magazine well adapter into a vice or clamp.

The combination of the magazine well hinge and the arm being able to rotate in a direction 1008, and slide in a direction of 1006 allow the platform or firearm to be placed and secured in a multiple of orientations in three degrees of freedom.

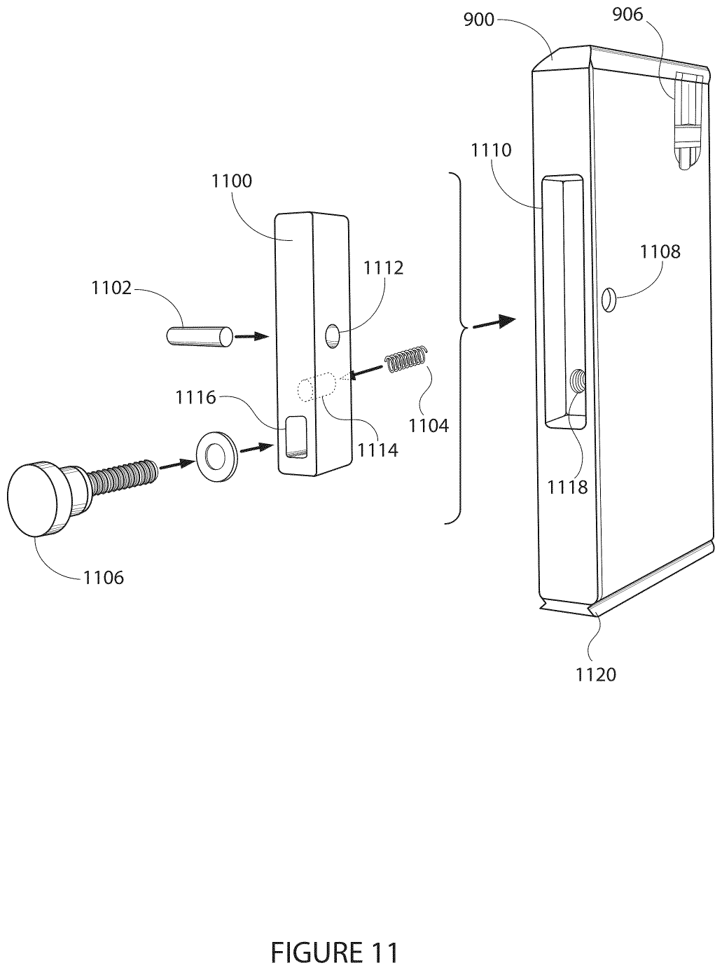

Referring to FIG. 11, the magazine well adapter 900 may include a hinged adjustor comprising a hinged adjustor bar 1100, a retention rod 1102, a spring 1104, and an adjustor knob 1106. A retention rod hole 1112, an adjustor knob hole 1116, and a spring pocket 1114 are defined in the hinged adjustor bar 1100. The hinged adjustor bar 1100 is generally thought of in two portions divided along the retention rod hole 1112 where the upper portion is proximal the top portion 902 of the magazine well adapter 900 and the lower portion is proximal the bottom portion 904 of the magazine well adapter 900. A hinged adjustor pocket 1110 is defined in the magazine well adapter 900 and a threaded hole 1118 is defined within the hinged adjustor pocket 1110. The hinged adjustor bar 1100 is recessed within the hinged adjustor pocket 1110. The hinged adjustor bar 1100 is held within the hinged adjustor pocket 1110 by the retention rod 1102 which passes through hole 1108 in magazine well adapter 900 and retention rod hole 1112. The hinged adjustor bar 1100 is oriented so that spring pocket 1114 and adjustor knob hole 1116 are proximal the bottom side 904 of the magazine well adapter 900 and the adjustor knob hole 1116 is functionally aligned with threaded hole 1118. The spring pocket 1114 faces inward towards the hinged adjustor pocket 1110 and is configured to accept spring 1104. Spring 1104 is between magazine well adapter 900 and the hinged adjustor bar 1100 and located in spring pocket 1114. Spring 1104 biases the bottom portion of the hinged adjustor bar 1100 outward from the magazine well adapter 900. When the bottom portion of the hinged adjustor bar 1100 is moved outward from the magazine well adapter 900, the top portion inversely moves inward the magazine well adapter 900. When the bottom portion of the hinged adjustor bar 1100 is moved inward the magazine well adapter 900, the top portion inversely moves outward the magazine well adapter 900. The recess pocket 1110 allows the bulk of the hinged adjustor bar 1100 to be recessed within the magazine well adapter 900. Adjustor knob 1106 connects to a threaded shaft which passes through adjustor knob hole 1116 and threads into threaded hole 1118 within hinged adjustor pocket 1110. While in FIG. 11 the hinged adjustor is shown on the end of the magazine well adapter distal the magazine latch area 906, it could be located on either end or side of the magazine well adapter.

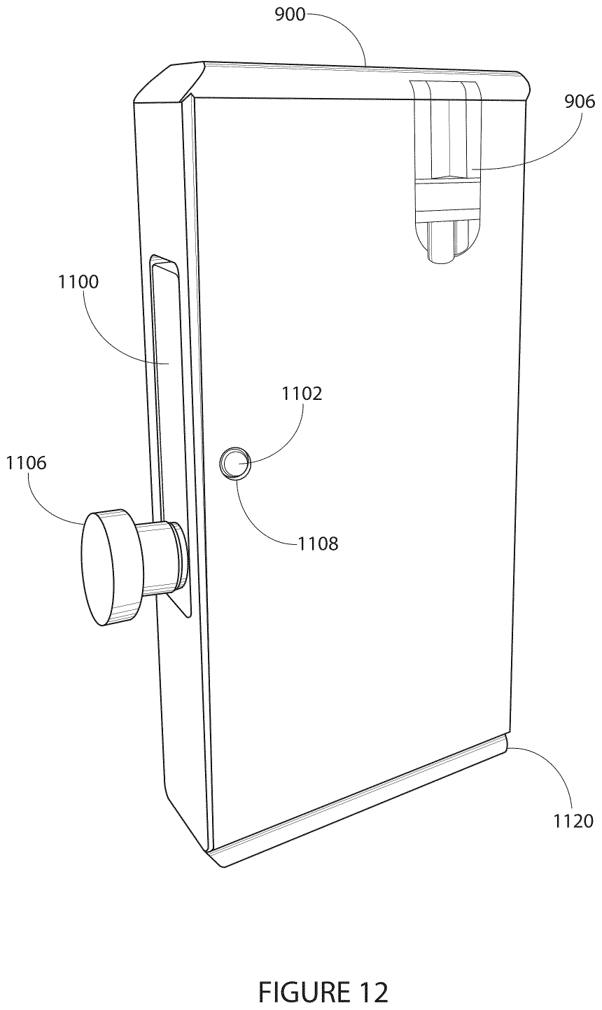

Referring to FIG. 12, the magazine well adapter of FIG. 11 is shown assembled. When the top portion 902 of the magazine well adapter 900 is inserted into a magazine well, the hinged adjustor bar 1100 should lie partially within the magazine well and partially without. Properly positioned, the top portion of the hinged adjustor bar 1100 will lie within the firearm magazine well and the retention rod 1102 and bottom portion of the hinged adjustor bar 1100 will be immediately outside the magazine well adapter. When adjustor knob 1106 is tightened, the adjustor knob 1106 moves inward relative to the magazine well adapter 900 placing pressure upon the bottom portion of hinged adjustor bar 1100 and pushing the same into the recess pocket 1110. As the bottom portion of hinged adjustor bar 1100 is pushed into recess pocket 1110, the hinged adjustor bar rotates along the longitudinal axis of the retention rod 1102 and the upper portion of the hinged adjustor bar 1100 pivots out of the recess pocket 1110. When the upper portion of the hinged adjustor bar 1100 pivots outward, it comes into contact with the magazine well of the firearm and places tension upon the magazine well. This tension secures the firearm upon the magazine well adapter 900 providing a stable platform upon which the user can work. To remove the firearm, the hinged adjustor knob 1106 is loosened allowing spring 1104 to push the bottom portion of hinged adjustor bar 1100 outward from magazine well adapter 900. As the bottom portion of hinged adjustor bar 1100 is pushed outward, the hinged adjustor bar is rotating along the longitudinal axis of retention rod 1102 and the upper portion of the hinged adjustor bar 1100 moves inward the recess pocket 1110 of the magazine well adapter 900 removing the tension within the magazine well of the firearm. When the tension is removed, the magazine release on the firearm may be activated disengaging the catch of magazine latch section 908 allowing the firearm to be removed from the magazine well adapter 900. The distal end of the magazine well adapter can include a rail 1120 which can include physical characteristics of a rail mounting system used for a firearm but attached to the magazine well adapter.

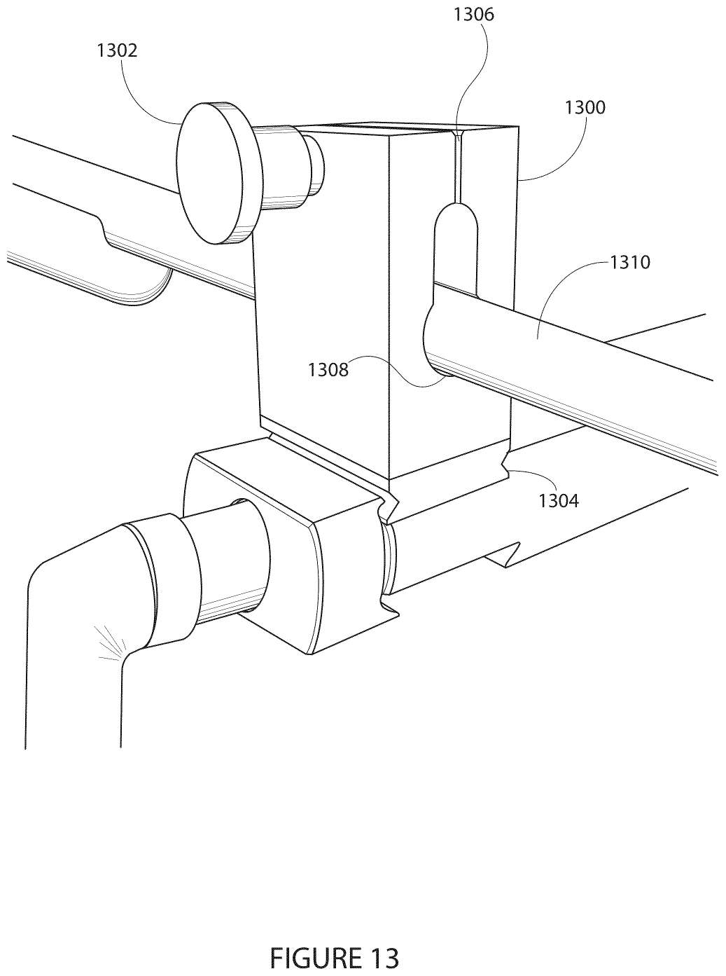

Referring to FIG. 13, a firearm barrel adapter 1300 can be adapted to receive within barrel hole 1308 the barrel 1310 of a firearm. Once barrel 1310 is inserted into barrel hole 1308, the barrel hole may be closed by tightening barrel adjustor knob 1302. Barrel adjustor knob 1302 is connected to a threaded shaft that runs through a first portion of firearm barrel adapter 1300, pass through gap 1306, and is threaded into a second portion of firearm barrel adapter. Gap 1306 can be reduced when the barrel adjustor knob 1302 is tightened squeezing the first and second portion of the firearm barrel adapter 1300 together. This adjustment works similar to handle 102 and the associated features in the vise block 100. By this method, the barrel 1310 of the firearm can be securely held within the firearm barrel adapter 1300. The distal end of the firearm barrel adapter 1300 can include a rail 1304 which can include physical characteristics of a rail mounting system used for a firearm but attached to the firearm barrel adapter. Therefore, a firearm platform without a rail adapter can be secured by the barrel using the firearm barrel adapter and the firearm barrel adapter can be secured to the clamp to hold the platform in a specific location. This also allows the platform to rotate and slide relative to the vise so that the platform can be moved between orientations to facilitate maintenance, the addition of attachments, removal or attachments and the like.

It is understood that the above descriptions and illustrations are one embodiment using a vise that can receive a platform with a rail. The vise can also be adapted to receive other attachment points on other platforms. For example, hunting rifle can include a sling swivel stud mount which can be used to attach the platform to the vise. In one embodiment, adapters that can be attached to the platform and the vise can be used.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A support system comprising:
a vise having a tight configuration and a loose configuration;
an arm held within the vise and having a distal end, a proximal end, and a guide rod opening and a tightening member opening defined in the arm at the proximal end;
a sliding jaw having a guide rod adapted to be received into the guide rod opening and a tightening member hole in operable communication with the tightening member opening in the proximal end of the arm;
a first mating surface defined by a first plane anchor edge of the proximal end of the arm and a first plane mating edge of the sliding jaw adapted to receive an accessory rail; and,
an adjustment knob attached to a threaded shaft extending through the sliding jaw and into the tightening member opening in the proximal end of the arm wherein the arm and the sliding jaw define a tight position and a loose position wherein when the adjustment knob is rotated in a first direction the sliding jaw moves away from the arm towards the loose position and when the knob is rotated in a second direction the sliding jaw moves toward the arm towards the tight position.

2. The support system of claim 1 further comprising a spring disposed within the guide rod opening adapted to bias the sliding jaw toward the loose position.

3. The support system of claim 1 wherein the accessory rail is taken from the group consisting of a picatinny rail, arca rail, dovetail rail, Warsaw Pact rail, weaver rail, SOPMOD, Magpul M-LOK, UIT rails, freeland rail and any combination.

4. The support system of claim 1 where the sliding jaw guide rod is cooperatively associated with the guide rod opening defined in the arm to allow the sliding jaw tolerance to compensate for a defect in the accessory rail as the sliding jaw moves from the loose position to the tight position.

5. The support system of claim 1 wherein the arm includes a second plane at the proximal end, and a second mating surface, defined within the second plane, and configured to accept one side of a second sized accessory rail on the second plane of the arm and wherein the attachment end of the sliding jaw is further configured to accept another side of the second sized accessory rail on the second plane of the arm.

6. The support system of claim 1 wherein the vise includes a clamping knob to tighten and loosen the vise about the arm and the arm can be manipulated in the vise by rotating about an axis of the arm and sliding from side to side along the axis of the arm.

7. The support system of claim 1 wherein the vise includes a tool receptacle.

8. The support system of claim 7 wherein the tool receptacle is threaded.

9. The support system of claim 1 wherein the vise includes a top recessed to form a tray.

10. The support system of claim 1 wherein the vise includes a magnetized portion.

11. The support system of claim 1 wherein the distal end of the arm includes a protrusion outward the arm and the vise includes a stop engaging the protrusion preventing the arm from disengaging the vise.

12. The support system of claim 1 further comprising a mounting platform having a mounting point capable of affixing to a surface, an accessory connector, and wherein the vise is affixed to the mounting platform.

13. The support system of claim 1 wherein the proximal end of the arm is contoured to accept an item being held by the accessory rail.

14. A support system comprising:
an arm having a distal end, a proximal end, and a tightening member opening defined in the arm at the proximal end;
a sliding jaw adapted to be received to the proximal end of the arm;
a first mating surface, defined by a first plane anchor edge of the proximal end of the arm and a first plane mating edge of the sliding jaw, adapted to receive an accessory rail; and,
an adjustment knob attached to a threaded shaft extending through the sliding jaw and into the tightening member opening in the proximal end of the arm wherein the arm and the sliding jaw define a tight position and a loose position wherein when the adjustment knob is rotated in a first direction the sliding jaw moves away from the arm towards the loose position and when the knob is rotated in a second direction the sliding jaw moves toward the arm towards the tight position.

15. The support system of claim 14 wherein the sliding jaw includes a guide mechanism cooperatively associated with a receiving mechanism defined in the arm which together align the sliding jaw to the arm while allowing tolerance to compensate for a defect in the accessory rail as the sliding jaw moves from the loose position to the tight position thus maintaining alignment to securely engage the accessory rail.

16. A magazine well adapter comprising:
a magazine block with a proximal end and a distal end wherein the proximal end is adapted to be partially received in a platform opening and the distal end includes a mounting surface;
a tightening member received within a recess within the proximal end of the magazine block such that a portion of the tightening member is received within the platform opening;
an adjustment knob attached to a threaded shaft extending through the tightening member into the proximal end of the magazine block wherein the magazine block and tightening member define a tight position and a loose position wherein when the adjustment knob is rotated in a first direction the tightening member moves outward from the proximal end of the magazine block within the platform opening towards the tight position and when the knob is rotated in a second direction the tightening member moves inward the proximal end of the magazine block within the platform opening towards the loose position.

17. The magazine well adapter of claim 16 wherein the proximal end of the magazine block is rotatably attached to the distal end of the magazine block and further comprising:
a handle attached to a shaft connecting the proximal end of the magazine block to the distal end of the magazine block and defining a moveable position and a secured position wherein when the handle is rotated in a first direction the proximal end of the magazine block and distal end of the magazine block can rotate relative to one another where attached and when the handle is rotated in a second direction the proximal end of the magazine block and distal end of the magazine block are secured to one another.

18. The magazine well adapter of claim 16 wherein the platform opening is a magazine well.

19. The magazine well adapter of claim 16 wherein the mounting surface is compatible with a rail taken from the group consisting of a picatinny rail, arca rail, dovetail rail, Warsaw Pact rail, weaver rail, SOPMOD, Magpul M-LOK, UIT rails, freeland rail and any combination.
